(19) United States
(12) Patent Application Publication
(10) Pub. No.: US 2019/0131050 A1
(43) Pub. Date: May 2, 2019

(54) MONOLITHIC 3D INDUCTOR

(71) Applicant: Sumida Technologies Inc., Kingston (CA)

(72) Inventors: Hamid DANESH pajooh nejad, Kingston (CA); Douglas James MALCOLM, Kingston (CA)

(21) Appl. No.: 16/115,698

(22) Filed: Aug. 29, 2018

Related U.S. Application Data
(60) Provisional application No. 62/580,192, filed on Nov. 1, 2017.

(51) Int. Cl. H01F 17/00; H01F 41/04; H01F 27/24; H01F 27/28; H01F 41/06

(52) U.S. Cl. CPC H01F 17/0013; H01F 17/0033; H01F 41/041; H01F 2027/2809; H01F 27/2804; H01F 41/06; H01F 27/24

(57) ABSTRACT

An inductor having a monolithic core that has a void or space underneath. In some embodiments, the core comprises multiple core pieces; in other embodiments, the core comprises a unitary core piece. The void allows for other electrical components to be mounted underneath the inductor, on the PCB or other substrate to which the inductor is to be mounted. The inductor may have one or more coils, and each coil may be a single turn or a multi-turn coil. The coils can be embedded within the core once the inductor is assembled. The inductor may have an air gap within the core.

### RELATED APPLICATIONS

This application is a non-provisional of US Provisional Patent Application No. 62/580,192, filed Nov. 1, 2017.

### TECHNICAL FIELD

The present invention relates to electrical components. More specifically, the present invention relates to structures for use in inductors.

### BACKGROUND

The magnetic elements used in electronic circuits normally consist of two main parts: one or more coils that are the current-carrying conductors, such as copper wire, and a magnetic core assembly made from magnetic materials such as ferrite or iron powder. An air core is also an option for such devices. Inductors are available as pre-made fixed electronic components or can be assembled by the customer, using separate magnetic cores and wires, and possibly some other accessories such as a bobbin, that are available in a variety of standard shapes and sizes. These custom magnetic elements must be assembled and tested separately before being used as a component in the targeted system. Today, custom magnetics such as planar magnetics may be assembled directly on a substrate, such as the commonly used multilayer PCB (printed circuit board). Such direct assembly saves a lot on testing and production time, but is expensive to implement due to specific requirements of the substrates (requirements such as PCB layer number and current rating). Moreover, directly assembled PCBs may not be optimal for high density designs.

Alternatively, in modern designs, the so-called 3D construction can be used. In conventional electronic boards, components are mounted on the surface of the board side-by-side and the design is two dimensional. With a 3D design, the overall volume or footprint size of the design can be reduced by assembling some components on top of others. Current demand for higher-density boards is not only for smaller final product size. This demand is also fuelled by the reduction in overall system cost afforded by smaller sized boards and components. Such smaller boards and components require less packaging, shipping, support structures, etc. and can thereby lead to lower costs overall.

In terms of known inductor designs, current designs have some drawbacks. One example of the prior art is illustrated in FIG. 1. In FIG. 1, illustrated is a conventional high current DC inductor structure. The long inductor terminations in a low number-of-turn inductor increase the resistance of the inductor (DCR) significantly but do not effectively contribute to the inductance. Unfortunately, this leads to less than desirable overall performance.

There is therefore a need for structures that can be used in 3D designed boards and that can provide the advantages of 3D designs while avoiding the pitfalls of the prior art.

### SUMMARY

The present invention provides an inductor having a monolithic core that has a void or space underneath. In some embodiments, the core comprises multiple core pieces; in other embodiments, the core comprises a unitary core piece. The void allows for other electrical components to be mounted underneath the inductor, on the PCB or other substrate to which the inductor is to be mounted. The inductor may have one or more coils, and each coil may be a single turn or a multi-turn coil. The coils can be embedded within the core once the inductor is assembled. The inductor may have an air gap within the core.

In a first aspect, the present invention provides an inductor comprising:
a monolithic core; and
at least one coil for surrounding at least a substantial portion of an inner portion of said core;

wherein
said inductor comprises a void between said core and a substrate on which said inductor is installed; and
said at least one coil is electrically coupled to said substrate.

In a second aspect, the present invention provides an inductor comprising:
a monolithic core assembled from at least two core pieces, said core having a channel within to define an inner portion; and
at least one coil that surrounds said inner portion, said at least one coil being positioned within said channel, said at least one coil being electrically coupled to a substrate when said inductor is installed on said substrate.

### BRIEF DESCRIPTION OF THE DRAWINGS

The embodiments of the present invention will now be described by reference to the following figures, in which identical reference numerals in different figures indicate identical elements and in which:

FIG. 1 shows an inductor according to the prior art;

FIGS. 2A and 2B illustrate an inductor according to one aspect of the invention;

FIGS. 3A and 3B illustrated an inductor according to a variant of the inductor shown in FIGS. 2A and 2B;

FIGS. 4A and 4B show yet another variant of the inductor shown in FIGS. 2A and 2B;

FIGS. 5A-5C illustrates a single core implementation of a variant of the inductor shown in FIGS. 2A and 2B;

FIGS. 6A-6G show different variants of the coil used in one aspect of the present invention;

FIGS. 7A and 7B show a multi-turn variant of the inductor illustrated in FIGS. 2A and 2B;

FIGS. 8A and 8B show a multi-turn variant of the inductor illustrated in FIGS. 3A and 3B; and

FIGS. 9A-9F show different variants of inductor cores with different types of air gaps.

### DETAILED DESCRIPTION

In one aspect, the present invention provides new structures for implementing 3D magnetics with an emphasis on inductors using custom coils and cores. Using this approach, each part of the inductor can be treated as an individual component during board assembly and the whole magnetic element can be assembled and formed from its individual parts in the board level and not in a separate process. These structures are well suited for fast assembly and testing (either manual or automated manufacturing). These structures also serve as packaging for electronic modules such as point of load (POL) modules. The whole package may cover the whole module or a portion thereof, such that external packaging is not required. Compared to other packaging methods used for the modules such as plastic, epoxy, potting, etc., the magnetic package of the present invention results in a device that occupies a smaller volume, has improved thermal performance, and has reduced radiated electromagnetic noise.

Among other applications, the present invention is particularly applicable to high current, high frequency magnetic components, especially inductors. The 3D structure of the present invention is also very suitable for DC inductors that require nonlinear values (e.g., devices that use air gap stepping or uneven air gap). Such nonlinear inductances can significantly improve the no-load/light-load efficiency of power electronic converters. Higher inductance at lower currents reduces the light load circulating (reactive) currents and their associated losses.

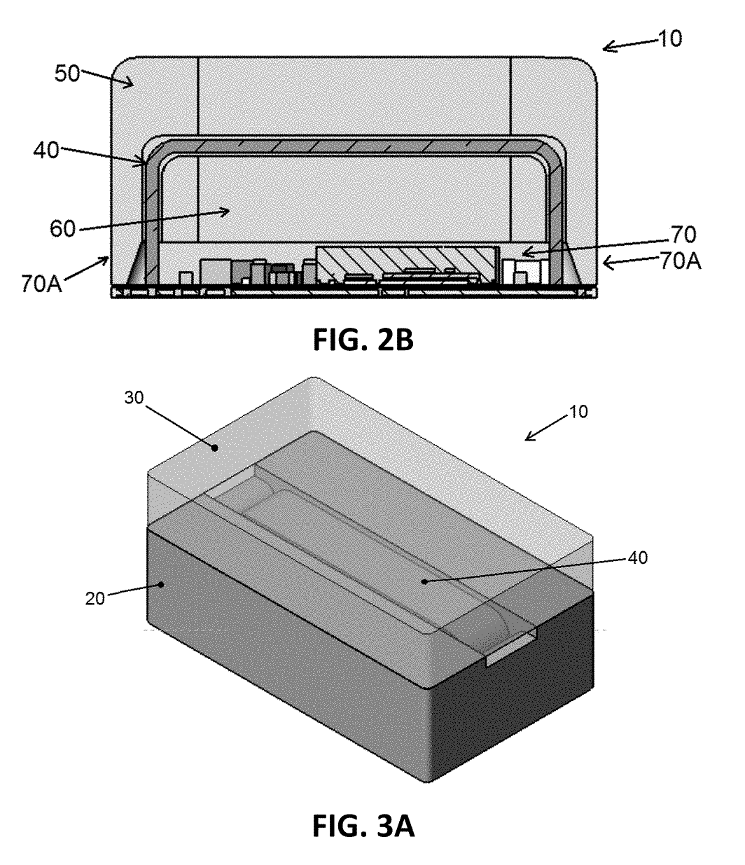

The various aspects of the present invention seek to provide a number of advantages and features. FIGS. 2A, 2B, 3A, 3B, 4A, 4B, 5A-5C, 7A-D, and 9A-9F show various implementations of one aspect of the present invention.

In an inductor implementation of the present invention, the device serves as a full or partial packaging for, among others, DC-DC POL regulators. In addition, the present invention simplifies and improves the speed of assembly and testing of 3D modules since inductor parts can be treated as individual (discrete) electronic components. In one example, standard pick and place machines can be used to mount the coil of the inductor aspect of the present invention along with other electronic components on the board before reflow soldering is applied. After soldering (i.e., once the coil has been installed), the assembly can be visually and functionally tested with suitable access to components without the issue of cores blocking the other components. Removable test cores may be used for initial board testing. Finally, after testing the other components and the coil itself if necessary, the cores can then be assembled and glued to each other to form the package.

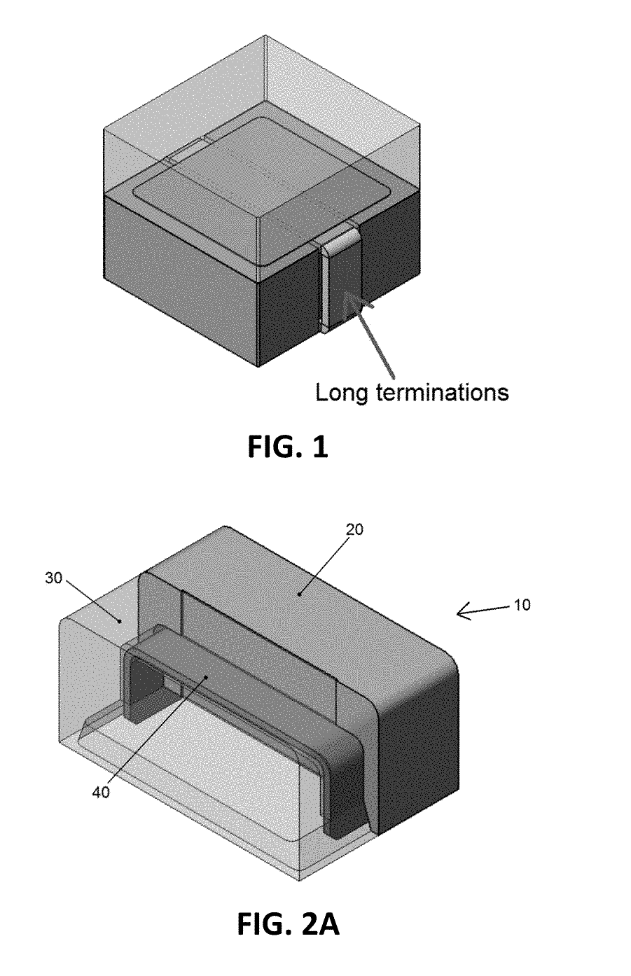

A further advantage afforded by the present invention is the minimization of direct current resistance (DCR) for inductors. The present invention minimizes the resistance (DCR) of the inductor for a given size and magnetic performance by using the maximum length of the conductor (coil) that contributes to the inductance. This can be important, especially for high current, high frequency inductors that only have a single turn or a few turns for the coil. (Single turn coils may also be referred to as “three-quarter turn” coils, depending on the implementation.) In conventional inductors, the terminations increase and may even double the overall DCR of the inductor (a typical example is shown in FIG. 1).

Another advantage provided by the present invention is the lessening of magnetic noise. The present invention provides minimal magnetic noise coupling to nearby components because of the fully magnetic surrounding (i.e., shielding) of the coil and terminations. As can be seen from the Figures, the coil and the terminations are fully or at least mostly shielded or surrounded by the core. In most of the implementations, the coil is not visible as it is obscured or hidden by the core.

The present invention also allows pins and solder joins to be hidden. In the prior art, inductor wires and other parts may be visible even if a void structure is used. In the present invention, however, the pins and solder joins are hidden by the core and these invisible pins and solder joins make these inductor structures preferable for 3D packaging that may need non-visible terminals. Additionally, covering all or almost all of the components with the magnetic body increases the inductance, improving the present invention's performance relative to the prior art.

Moreover, the smaller size of the present invention, as compared to the prior art, frees more space on the circuit board (or similar substrate) than traditional structures. Further, the design of the present invention allows the full footprint of the structure to be effective. Traditional structures include packaging material that takes up board space but does not contribute to the performance of the inductor. In the present invention, however, as no packaging material is needed, the inductor body can be extended to cover the entire possible footprint on the substrate. The absence of packaging material provides a further advantage, in that magnetic materials transfer heat more effectively than the plastics, epoxies, etc. used for packaging. Thus, the present invention dissipates heat faster than structures in the prior art.

As will be explained below, the present invention also allows for easy implementation of nonlinear inductances by using stepped or profiled air gaps on the cores.

A further advantage is the easy modification of the inductor to trim the inductor value or to cover a range of requirements on similar designs that may use or require the same inductor footprint. The inductance value can be modified to match the application requirements without the need to order new custom magnetic parts or the need to make new expensive toolings for custom cores and coils. For such modifications, adjusting the air gap in the core adjusts the inductance of the device.

Referring to FIG. 2A, an embodiment of the present invention is illustrated. As can be seen, the inductor 10 has a first core piece 20, a second core piece 30, and a coil piece 40. The first core piece 20 and the second core piece 30 are designed to cooperatively couple to each other and, when assembled together, to form a single, monolithic block of magnetic material that forms the core of the inductor. The coil piece 40 surrounds/encloses a portion of the core. When the two core pieces 20, 30 are assembled together, the coil piece 40 is hidden or buried within the single block of magnetic material that forms the core. It should be clear that, in FIG. 2A, the first core piece 20 is shown as solid while the second core piece 30 is shown in outline. The monolithic block of magnetic material that constitutes the core is, mostly, solid. In one implementation, the two core pieces are configured to mate and cooperate with each other when the core is assembled.

For a better understanding of the embodiment illustrated in FIG. 2A, a front cut-away view of an installed inductor according to the embodiment in FIG. 2A is shown in FIG. 2B. As can be seen, the inductor 10 has a core with a top portion 50, an inner portion 60, and a coil 40. The inner portion 60 of the core is not very visible in FIG. 2A, as it is covered by the coil 40, but in FIG. 2B, this inner portion is clearly visible. As can also be seen in FIG. 2B, underneath the inductor 10 is a void/cavity or space 70. This void 70 is directly underneath the inner portion 60 of the core. The sides of the top portion 50 are typically in contact with the substrate on which the inductor is mounted and enclose the void 70. (It should be noted, however, that in some implementations, the sides of the core are not required to be in contact with the substrate.) The bottom of the inner portion 60 is spaced away from the substrate, thereby creating the void 70. As can be seen, the void 70 allows components to be installed on the substrate such that when the inductor 10 is fully assembled, these components are underneath the inductor 10. The coil 40 is attached to the substrate, by soldering or any other suitable attachment method that allows electrical signals to pass to and from the coil and the substrate. As can be seen, the coil 40 is placed within a channel that defines the inner portion of the core and the upper portion of the core. Of course, the inner portion still constitutes part of the core. The channel is essentially a groove in the side wall of the core that separates the inner portion and the upper portion. Magnetic flux circulates between the inner and upper core portions through the wall, which thus forms a magnetic path when both core pieces 20 and 30 are attached together.

One method for the assembly of the inductor 10, as explained above, allows for installation and testing of the components underneath the inductor 10. Prior to installing any of the parts of the inductor 10 on a substrate such as a circuit board, the components that are to be underneath the inductor 10 are first installed on the substrate in the area that would be defined by the void 70. Once the components are installed, the coil 40, by itself, is then installed on the substrate. The coil can then be tested along with the components already installed. Once testing has been completed, the two pieces of the core can be installed. For this step, the first core piece is installed and placed on the substrate with its inner portion being located underneath the coil as in FIG. 2B. The second core piece is then placed and its inner portion is also located underneath the coil. The two core pieces are then joined to form a single monolithic core. The core pieces can be attached to the coil and/or to the substrate using a suitable adhesive.

It should be clear that the embodiment of the present invention illustrated in FIGS. 2A and 2B has a number of advantages. This embodiment has a core symmetry that requires only one piece of tooling (i.e., a mold) to manufacture the whole core. As well, the core pieces do not need to be inserted until after soldering the coil to the substrate and, thus, visual inspection and initial electrical testing of the coil can be accomplished as explained above. Another advantage to this embodiment is that it allows for a stepped air gap between the coil and the core, as will be explained below. As noted above, glue can be used to fix or attach the core pieces to the coil and to the substrate in the gapped area.

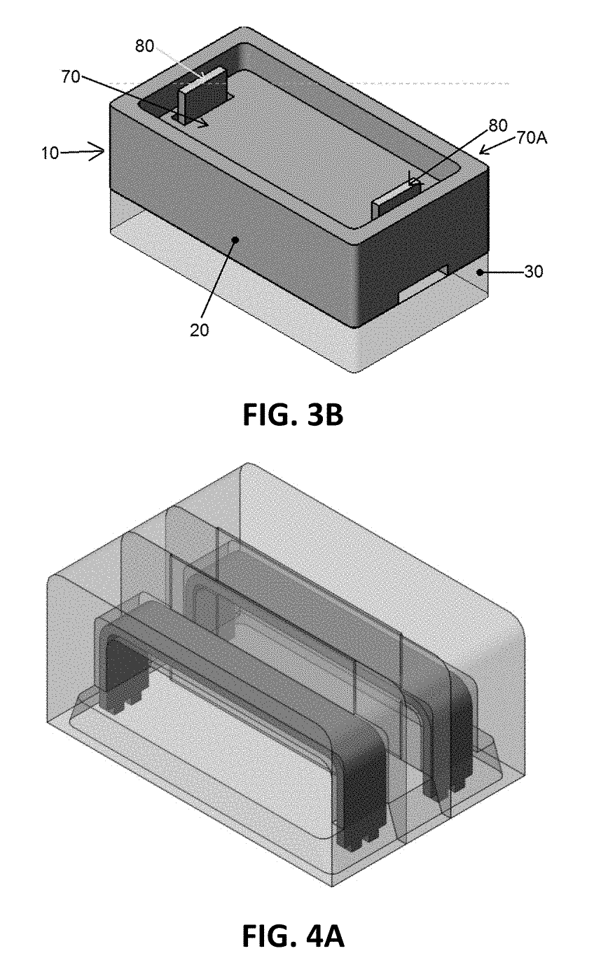

Referring to FIGS. 3A and 3B, another embodiment of the present invention is illustrated. In this embodiment, the inductor 10 has first core piece 20, second core piece 30, and coil 40. In contrast to the embodiment in FIGS. 2A and 2B, instead of having core pieces that are side-by-side, the core pieces in the embodiment in FIGS. 3A and 3B are on top of one another. In FIG. 3A, the first core piece 20 is below the second core piece 30. As can be seen, the coil wraps or surmounts the inner portion of the core (in this case the inner portion is part of the first core piece) and legs 80 of the coil protrude through the second core piece 30 into the void 70. Once the first core piece and the coil are positioned on the substrate, the coil can be soldered on to the substrate. The second core piece can then be attached (e.g., by glue or similar adhesive) to the first core piece, thereby completing the assembly of the inductor 10.

Additionally, the embodiment of the inductor 10 illustrated in FIGS. 3A and 3B can be fully assembled before the coil is soldered to the substrate. Such an embodiment is preferably used when visual inspection is not planned and quick automated production of the embodiment using pick and place machinery is intended.

It should be clear that the void 70 is defined by supports 70A at the bottom of the core. These supports 70A also form part of the core and extend downwardly past the bottom of the main body of the core. These supports can enclose a space that defines the void 70.

In some embodiments, there may be openings on the sides of the void 70. That is, the supports may not fully enclose the space underneath the main body of the core. Such openings may be preferred, for instance, to improve cooling performance.

The embodiment illustrated in FIGS. 3A and 3B has the advantage that the whole inductor can be assembled and glued with pick and place (P&P) machines during board assembly. After mounting all components necessary under the inductor, the bottom piece and the coil can be assembled and then installed atop these components. The top piece (the second core piece noted above) can then be mounted atop the bottom piece (i.e., the first core piece noted above). An air gap spacer can be located between the first and second core pieces to ensure an air gap between the coil and the second core piece. Such an air gap spacer may be, for instance, paper or wire, or any other suitable material. As noted above, glue or similar can be used to attach the top piece to the bottom piece. It should be clear that the top piece is shown in shadow in FIGS. 3A and 3B for clarity and that FIG. 3B shows a bottom view of the assembled device. FIG. 3A is an isometric view of the assembled device.

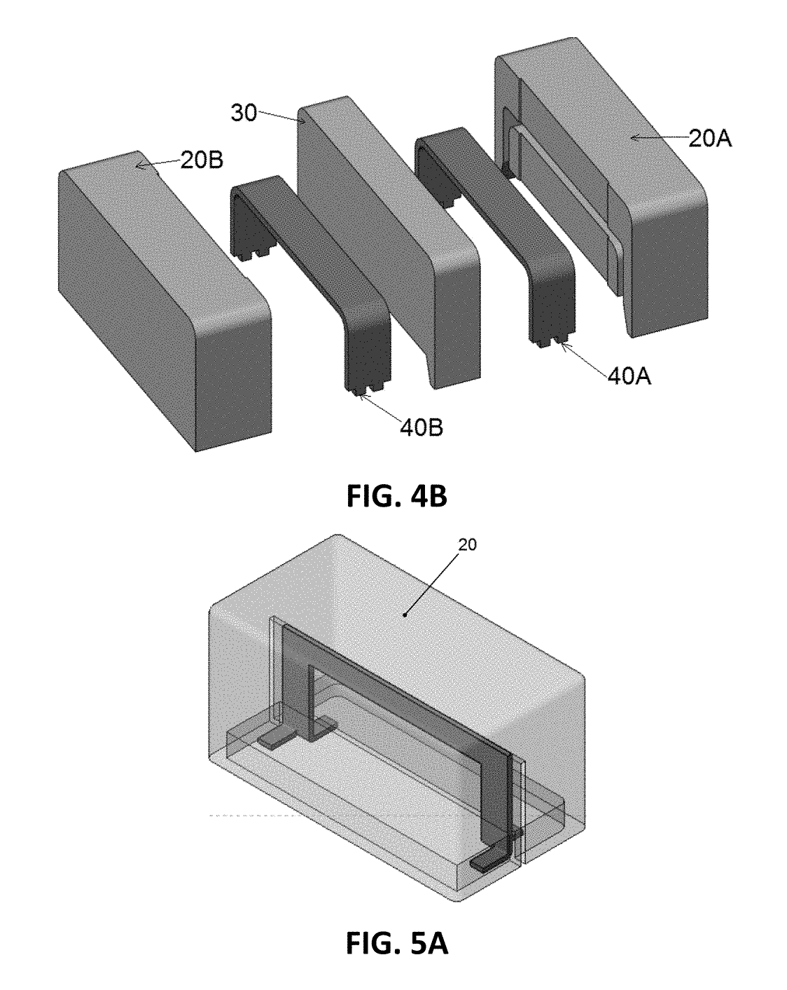

Referring to FIGS. 4A and 4B, a variant of the embodiment illustrated in FIGS. 2A and 2B is shown. This variant uses three core pieces and two coils. Again, many variants are possible, using one or more core pieces with one or more coils, the coils having one or more turns. For instance, one variant of the invention uses four coils, each coil having three turns. However, as would be clear to a person skilled in the art, the coils in a multi-coil inductor do not need to have the same number of turns. As can be seen in FIGS. 4A and 4B, two instances 20A, 20B of the first core piece are used along with a single second core piece 30. The coils 40A, 40B are also used to wrap or surmount the inner portions of the first core pieces 20A, 20B. As can be seen, the coil 40A would wrap around or surmount the inner portion of the first core piece 20A. Coil 40B would, similarly, wrap around or surmount the inner portion of the other first core piece 20B. The second core piece 30 would be attached to both the first core pieces 20A, 20B to form a single monolithic core. It should be clear that, when the inductor is assembled and mounted on a circuit board or other substrate, the bottom of the second core piece 30 is spaced away from the substrate such that the void underneath the inductor is continuous from the area underneath the first core piece 20A to the area underneath the first core piece 20B.

The variant illustrated in FIGS. 4A and 4B is useful for multiphase converters or other applications that need coupled inductors. As illustrated, compared to the two-piece approach illustrated in FIGS. 2A and 2B, one more core segment is inserted in between side cores to provide a coupled flux path. It should be clear that the core is shown in shadow in FIG. 4A while FIG. 4B illustrates an exploded view of the device. The center core in FIG. 4B (referred to as the second core piece 30 above) is sandwiched between the left side core and the right side core (referred to as the two first core pieces 20A, 20B above).

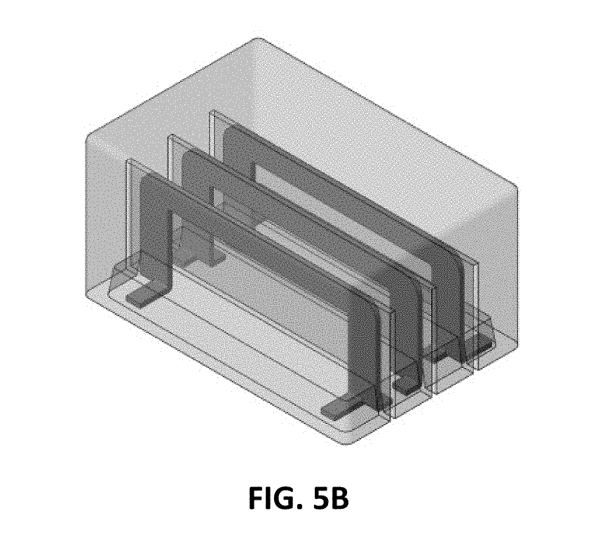

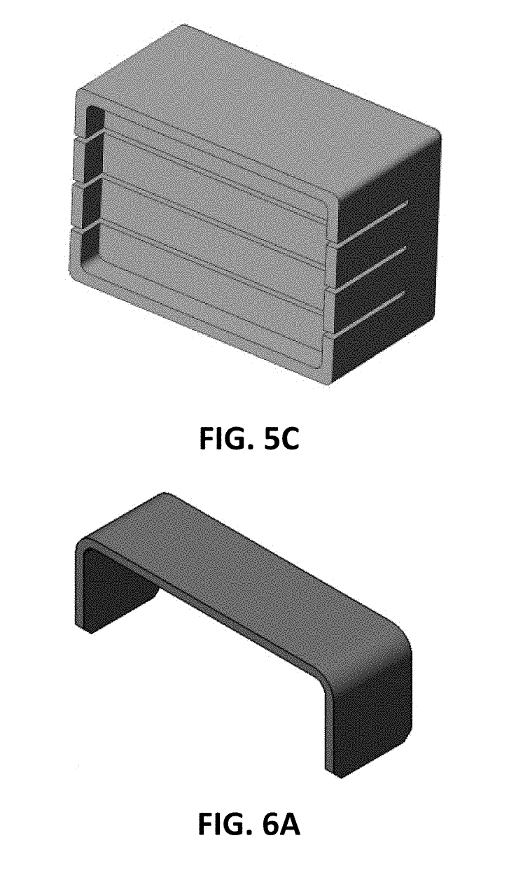

It should be noted that, in certain design conditions, if the coil thickness can be designed to be smaller than an air gap, the whole inductor can be implemented using only a single piece of slotted core block as shown in FIGS. 5A, 5B, and 5C. This variant of the present invention is a low-cost solution and the structure is easy to manufacture. This structure has all the advantages mentioned for the other variations but has limited wire thickness (as the wire thickness cannot exceed the width of the relevant air gap). It should be clear that the core is shown in shadow in FIGS. 5A and 5B and that, as with the other variants and embodiments, a void is still present underneath the inductor.

As noted, FIG. 5A shows a unitary core implementation of one aspect of the present invention (i.e., a monolithic core comprising a single core piece), having a single coil. The coil and core in this variant are very appropriate for pick and place mounting. The core is, essentially, a block of magnetic material with a slot cut to accommodate the coil within the core. This variant may be implemented using a single monolithic core with a slot cut into the core. The coil is installed on the substrate and the core is positioned to allow the coil to be inserted into the slot. In one implementation, the core is then slid on to the coil from above. In another implementation, the core is slid sideways on to the coil. Once the core is properly placed atop the coil (with the coil properly placed inside the slot), the core can be attached to the coil and/or the substrate using a suitable adhesive.

FIGS. 5B and 5C illustrate another single/unitary core implementation of one aspect of the present invention, with multiple coils. This implementation is similar to the single-core, single-coil implementation discussed above, except that multiple parallel slots are cut into the core.

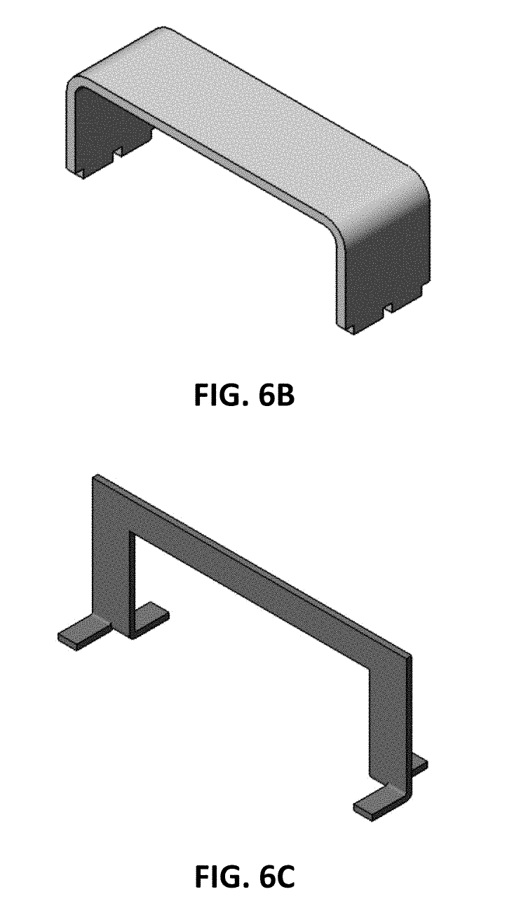

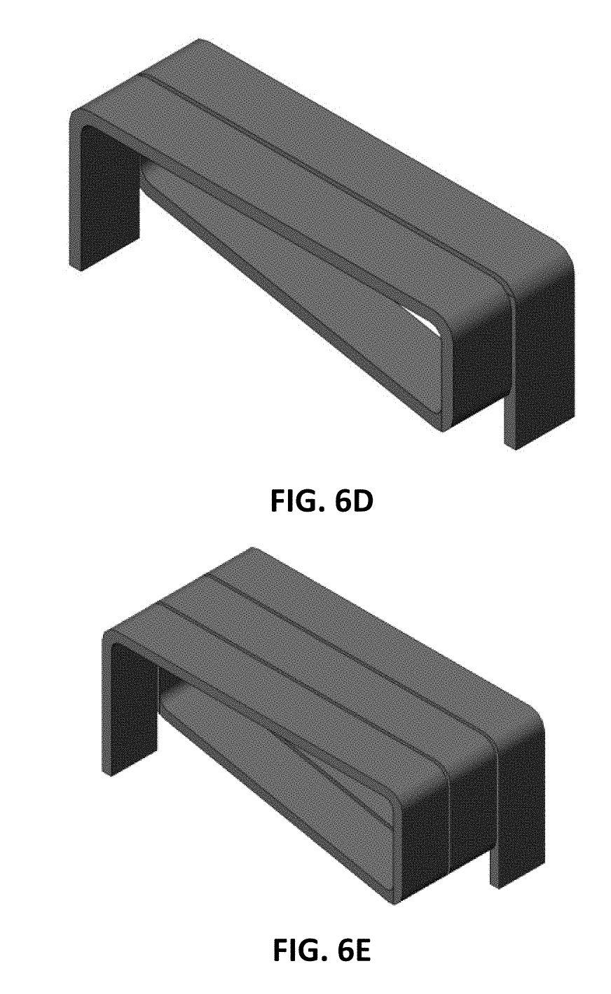

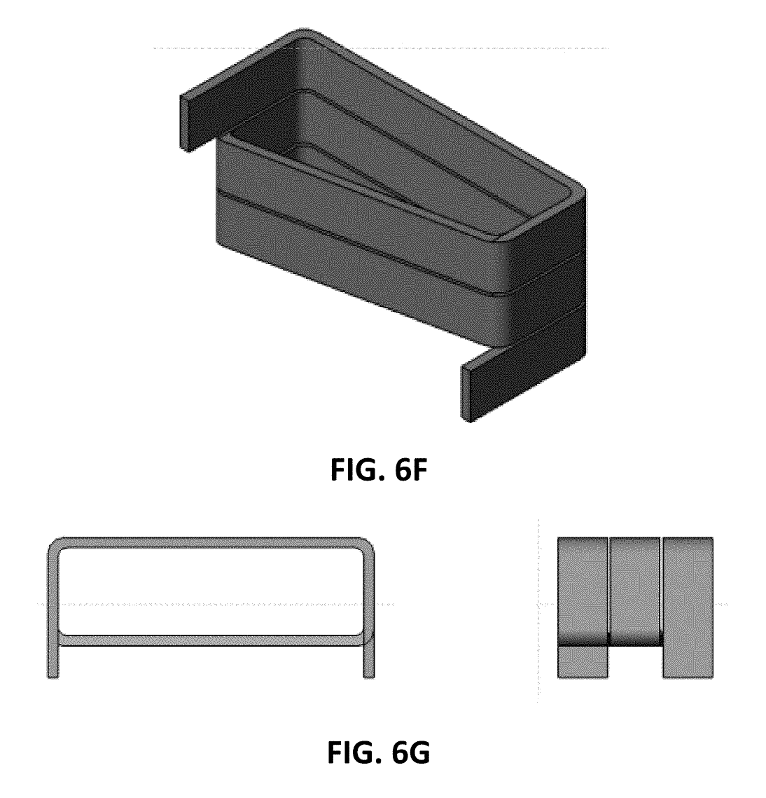

It should also be noted that, while multiple variants of the core are possible, the same holds true for the coil. Depending on the projected use of the inductor, the coil may have a single coil wrapped around the inner portion of the core or it may have multiple turns wrapped around the inner portion. Various aspects of the present invention can be useful for inductors with a low number of turns. Such inductors are typically used in high current, high frequency applications. For a coil with a low number of turns, the coil structure is simple and low cost, especially for one-turn coils that, in some embodiments, look like an inverted U shape conductor (see, specifically, FIG. 2B for an example). A coil with such a low number of turns can be made either by punching a copper sheet (e.g., a lead frame) or by forming standard flat copper wires as shown in FIG. 6A. For better solderability on tips, terminations can be toothed as shown in FIG. 6B. FIG. 6A shows a coil with a flat tip while FIG. 6B shows a coil with toothed tips. FIG. 6C shows a coil with right angled feet. Depending on the desired mounting method on the substrate, any one of the feet or tips at the end of the coil can be used.

As regards the number of turns, coils may have any number of such turns wrapped around an inner portion of the core. For clarity, a two-turn coil is shown in FIG. 6D, and a three-turn coil is shown in FIG. 6E. FIG. 6F shows a view of the three-turn coil of FIG. 6E from its underside; FIG. 6G shows the same three-turn coil in a side view and an end-on view.

The same method can be used for more turns of the coil, with the wire or coil being narrowed as necessary to accommodate the higher number of turns being wrapped around the inner portion of the core. In terms of implementation, however, if the wire is too narrow, the mechanical stability of a pick and place machine might be compromised.

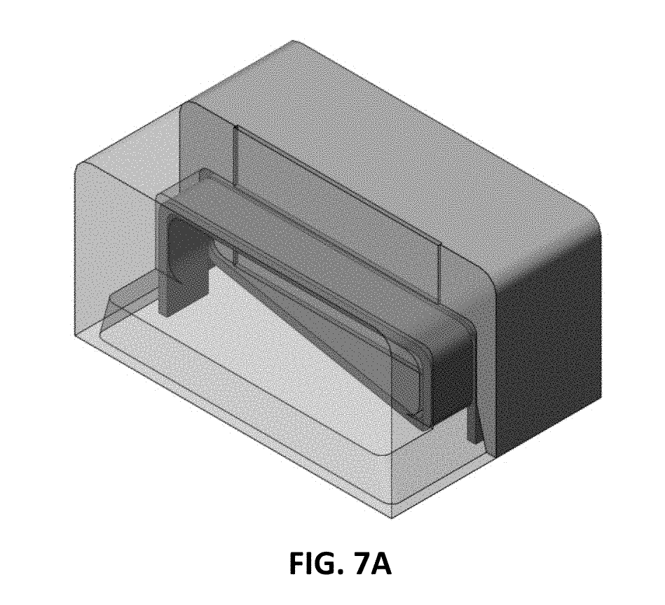

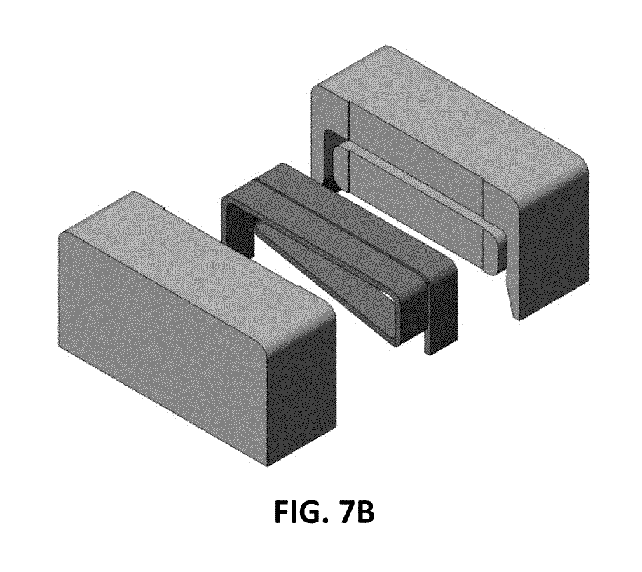

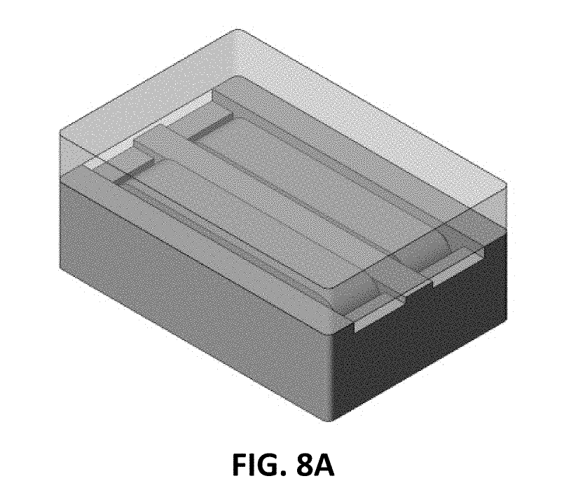

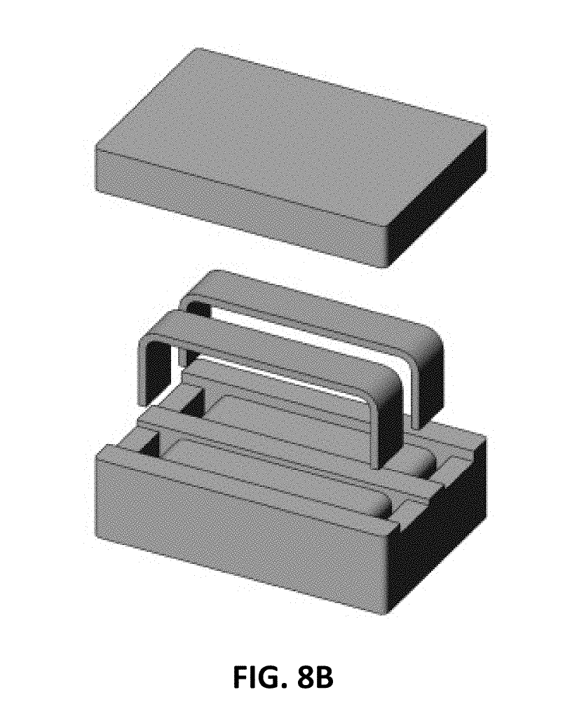

As noted above, multi-turn coils are possible. Examples of implementations using such coils are illustrated in FIGS. 7A and 7B, and FIGS. 8A and 8B. FIG. 7A shows an assembled inductor using a two-piece side-by-side core inductor with a multi-turn coil. The core configuration in the embodiment in FIGS. 7A and 7B is similar to the configuration of the core in the embodiment illustrated in FIGS. 2A and 2B. FIG. 7B shows an exploded view of the device illustrated in FIG. 7A.

FIG. 8A shows an assembled inductor using a two-piece top-bottom core inductor with a multi-turn coil. The core configuration in the embodiment in FIGS. 8A and 8B is similar to the configuration of the core in the embodiment illustrated in FIGS. 3A and 3B. FIG. 8B shows an exploded view of the device illustrated in FIG. 8A.

In applications with DC currents or in applications which need to stabilize the inductance value when high permeability core materials are used, an air gap is considered in the flux path inside the core. The air gap thickness (g) is designed based on the current level (saturation current) and the required inductance based on magnetic permeability and saturation of the core material along with geometrical dimensions. Conventionally, a thin layer of non-magnetic material is inserted between core segments to implement the designed air gap. An even (uniform) gap is the most commonly used type of gap and provides a fairly stable value for the inductance over the whole current range of the inductor. However, in some applications, an uneven gap is preferred to implement nonlinear inductance. For example, in power converters, a higher inductance at low currents can improve the efficiency of the converter in no load or light load conditions. This is because, when the converter output currents are small, most of the input current to the converter is reactive and is for exciting the magnetics and does not contribute to the output power. Therefore, a higher low-current inductance is preferred especially if the converter is operating for prolonged times with light load conditions, and where energy efficiency is important (e.g., battery powered applications).

One simple form of an uneven air gap is the stepped air gap. By implementing one or more steps (e.g., from no gap to a constant gap with a thickness of g) on the surface of the core pieces, the inductance versus current characteristics can be controlled because each segment of the core (related to a step) has a different reluctance and will saturate at a different level. For example, with a single step, two parallel reluctances appear in the magnetic flux path of the core. Part of the flux path includes no air gap while the rest of the flux in the core passes through the air gap. The no-gap area provides a high inductance at low currents and, if desired, can be designed to not saturate for less than, for instance, 10% of nominal current. At higher currents, however, that area of the core will saturate and thus provide only a very small portion of the total inductance. The gapped area, on the other hand, will provide most of the inductance value (i.e., almost constant over a wider range of current) until the whole core starts to saturate. Other uneven variable air gaps (such as a gradually increasing air gap) are also feasible to implement for similar applications.

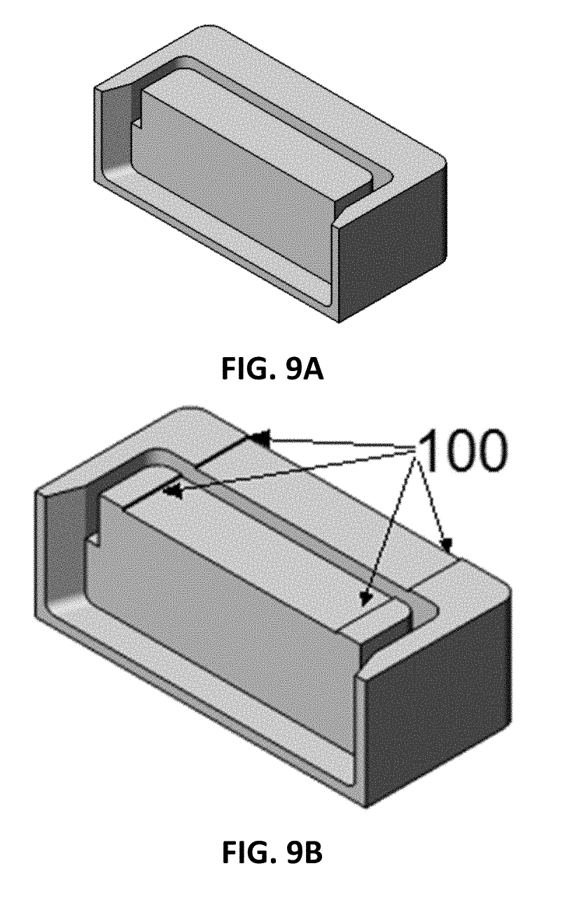

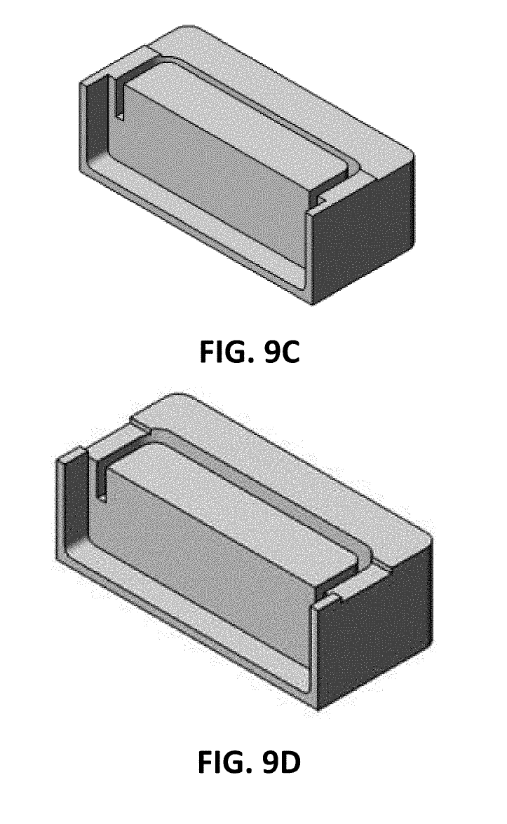

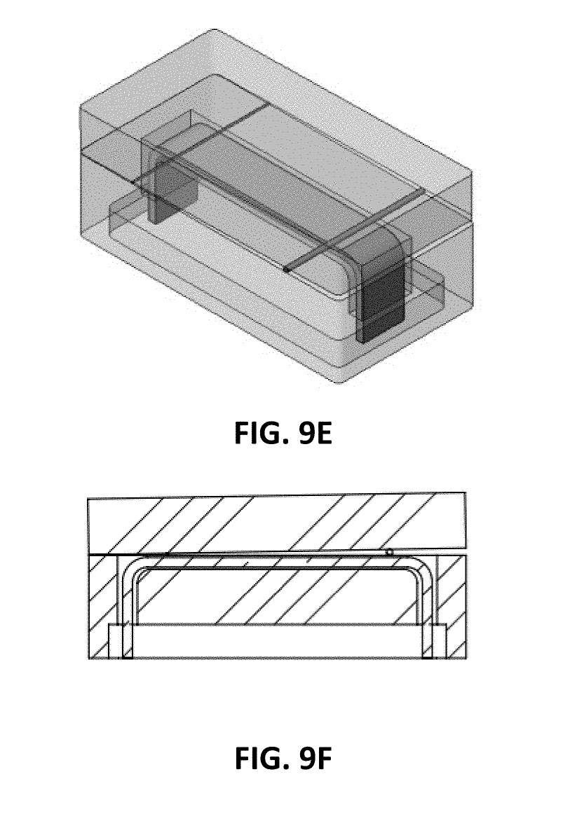

FIGS. 9A-9F illustrate core pieces used to implement air gaps in inductors according to another aspect of the present invention. These gaps are arranged such that they are practically implementable by core lapping with considerable tolerances in the width of the gaps. As can be seen, these core pieces implement uneven air gaps in inductors configured according to the various embodiments of the present invention. FIG. 9A shows one half of a two-piece core without an air gap while FIG. 9B shows a variant with a stepped vertical gap. In FIG. 9B, the steps 100 are present on the top part of the core piece and on the inner portion of the core. When assembled, the inductor would have an air gap between the first core piece and the second core piece, such that the top of the inductor would have an unevenly sized slot atop the inductor (with the slot being in the middle of the top of the inductor) and an equally unevenly sized or non-uniformly sized slot on the inner portion underneath the coil. The unevenness of the slot size would be due to the different thickness of the steps defining the slot with one end having a smaller thickness than the other end. An inductor with an evenly sized slot is, of course, also possible.

FIG. 9C shows a core with a stepped top. In FIG. 9C, the inductor, when assembled, would have a slot that runs from one side of the top of the inductor to the other side.

Alternatively, the air gap does not need to be on top of or atop the inductor. In FIG. 9D, the core has a bottom gap. When assembled, the inductor would have a slot on one piece of the core, or have slots on two opposite pieces of the core. In the case where there are slots on two opposite sides of the core, the slots are formed by grinding along the top side of the core with a grinding tool that extends across the entire width of the core. The width of the grinding tool determines the width of the slots. These slots operate as air gaps for the resulting inductor, and the depth of the grinding defines the actual thickness of the air gaps.

FIGS. 9E and 9F show variants with a gradually increasing variable air gap.

These variants have a configuration similar to the inductors illustrated in FIGS. 3A and 3B. It should be clear that the variants in FIGS. 9A-9D are for side-by-side implementations of the core (i.e., the core components or core pieces are assembled as being adjacent to each other) while the variant in FIGS. 9E and 9F is for a top-bottom core implementation. In the variant in FIGS. 9E-9F, as can be seen in FIG. 9F, the air gap is smaller at one end when compared to the other end. Spacers may be used to implement such an air gap with spacers at one end being larger than spacers at the other end (or no spacers being used at the other end). Gradual gapping options are also applicable to other structures.

From FIGS. 9A-9F, it should be clear that, for the side-by-side core implementations, three options for stepped air gaps are shown (FIGS. 9B-9D).

A variable (gradually increasing) air gap implementation is also shown for the top-bottom core shape (FIGS. 9E and 9F). Core lapping machines can be used to grind the gap in horizontal or vertical directions for a stepped air gap. Of course, the gap can be simply even for all of the structures as well as stepped or uneven.

In one embodiment, as described above, the present invention provides an inductor comprising a core for assembly into a single monolithic block, said core comprising at least two core pieces; and at least one coil for surrounding at least a substantial portion of an inner portion of said core; wherein, when said core is assembled, said inductor comprises a void between said core and a substrate on which said inductor is installed; and wherein said at least one coil is electrically coupled to said substrate.

In another embodiment, also described above, the present invention provides an inductor comprising: a unitary core; and at least one coil for surrounding at least a substantial portion of an inner portion of said core; wherein said inductor comprises a void between said core and a substrate on which said inductor is installed; and said at least one coil is electrically coupled to said substrate. In this embodiment, said at least one coil may have at least one turn. In another variant of this embodiment, said at least one coil may be a U-shaped conductor surrounding said inner portion of said core.

Additionally, in an embodiment having a unitary/single-piece core, said at least one coil may surround said inner portion of said core. Further, said at least one coil may surround said inner portion of said core multiple times. In one variant, said inductor comprises four coils and each of said four coils has at least one turn. In another alternative, said at least one coil may be surrounded by said core. Moreover, the embodiment with a unitary core may comprise a slot atop said core, said slot operating as an air gap for said inductor. This slot may cut across said top of said inductor from a side of said inductor to an opposite side of said inductor. In an alternative, wherein said core comprises at least one slot on at least one side of said core, said at least one slot operating as an air gap for said inductor. The gap may be variable in size.

A person understanding this invention may now conceive of alternative structures and embodiments or variations of the above all of which are intended to fall within the scope of the invention as defined in the claims that follow.

What is claimed is:

1. An inductor comprising:
a monolithic core; and
at least one coil for surrounding at least a substantial portion of an inner portion of said core;
wherein
said inductor comprises a void between said core and a substrate on which said inductor is installed; and
said at least one coil is electrically coupled to said substrate.

2. The inductor according to claim 1, wherein said at least one coil has at least one turn.

3. The inductor according to claim 1, wherein said at least one coil is a U-shaped conductor surrounding said inner portion of said core.

4. The inductor according to claim 1, wherein said at least one coil surrounds said inner portion of said core.

5. The inductor according to claim 1, wherein said at least one coil surrounds said inner portion of said core multiple times.

6. The inductor according to claim 1, wherein said inductor comprises a slot atop said core, said slot operating as an air gap for said inductor.

7. The inductor according to claim 6, wherein said slot cuts across said top of said inductor from a side of said inductor to an opposite side of said inductor.

8. The inductor according to claim 1, wherein, when said inductor is assembled, said at least one coil is surrounded by said core.

9. The inductor according to claim 1, wherein said core comprises at least one slot on at least one side of said core, said at least one slot operating as an air gap for said inductor.

10. The inductor according to claim 9, wherein said gap is variable in size.

11. The inductor according to claim 10, wherein said at least one slot is non-uniform in size.

12. The inductor according to claim 1, wherein said monolithic core comprises a single core piece.

13. The inductor according to claim 1, wherein said monolithic core is formed by assembly of at least two core pieces.

14. The inductor according to claim 13, wherein each of said at least two core pieces is constructed and arranged to mate with each other when said core is assembled.

15. The inductor according to claim 13, wherein said at least one coil surrounds said inner core of a first core piece of said at least two core pieces and a second core piece of said at least two core pieces is for attachable placement atop said first core piece.

16. The inductor according to claim 13, wherein said core comprises three core pieces, said three core pieces comprising two side pieces and a center piece, said center piece being sandwiched by said two side pieces when said core is assembled.

17. The inductor according to claim 13, wherein said at least two core pieces are for assembly into said core in a side-by-side manner.

18. The inductor according to claim 15, wherein, when said core is assembled, a gap exists between said first core piece and said second core piece, said gap operating as an air gap for said inductor.

19. The inductor according to claim 1, wherein said inductor comprises four coils and each of said four coils has three turns.

20. An inductor comprising:
a monolithic core assembled from at least two core pieces, said core having a channel within to define an inner portion; and
at least one coil that surrounds said inner portion, said at least one coil being positioned within said channel, said at least one coil being electrically coupled to a substrate when said inductor is installed on said substrate.

21. The inductor according to claim 20, wherein said core comprises supports that extend downwardly from a main body of the core, said supports extending past a bottom of said main body to thereby define a void underneath said bottom of the main body.
